(19) United States
(12) Patent Application Publication
(10) Pub. No.: US 2009/0252585 A1
(43) Pub. Date: Oct. 8, 2009

(54) Power bed slide - a hydraulic powered bed slide for pick-up trucks and other vehicles with cargo area

(76) Inventor: James M. Plaganis, Fallbrook, CA (US)

Correspondence Address: James Plaganis, 736 Del Valle Drive, Fallbrook, CA, 92028, US

(21) Appl. No.: 12/080,229

(22) Filed: Apr. 2, 2008

(51) Int. Cl. B62D 33/02; B65G 69/22

(52) U.S. Cl. 414/679; 296/193.08

(57) ABSTRACT

Prior to the invention of the hydraulic Power Bed Slide, the only forms of cargo bed slides available were manually operated. You were limited on the amount of weight the slide could hold, the slide could not be operated if cargo was on an incline and locking mechanisms were limited to the manufactures preset locations. Having an all steel, hydraulic powered bed slide allows for a much greater weight capacity, capability of moving cargo on any incline and infinite locking positions.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING A TABLE OR A COMPUTER PROGRAM LISTING COMPACT DISC APPENDIX

Not Applicable

### BACKGROUND OF THE INVENTION

The Power Bed Slide was originally designed to equip a truck with a manual, slide-out platform (bed) in 1978. In 1992 a hydraulic system was developed to operate the platform with a push button remote control. The product was introduced to the public at the Specialty Equipment Manufacturers Association (SEMA) show in Las Vegas in October, 2006 followed by the Work Truck Show in Indianapolis in March, 2007. In January, 2008, I designed and began manufacturing my own design of the hydraulic cylinder. I am presently manufacturing and selling the Power Bed Slide.

### BRIEF SUMMARY OF THE INVENTION

The Power Bed Slide is a hydraulic powered cargo slide for pick up trucks and other load carrying vehicles. It consists of a steel track system and a platform that moves in and out, horizontally to the vehicle bed (or floor in the case of a cargo van or delivery truck). It is operated by a hydraulic pump and motor mounted underneath the vehicle and is powered by the existing battery. It is designed to carry heavy cargo loads and extend and retract the cargo in and out of the vehicle cargo area with just the push of a button.

### BRIEF DESCRIPTION OF THE DRAWINGS

FIG. 1-5 Track system: Shows how to make left and right side tracks.

FIG. 2-5 Track system: Shows assembly of rungs to left and right tracks.

FIG. 3-5 Track system: Attach/weld angle iron to end of tracks to complete track system.

FIG. 4A-5 Components of hydraulic cylinder and assembly.

FIG. 4B-5 Exploded view of cylinder head.

FIG. 5-5 Assembly of platform.

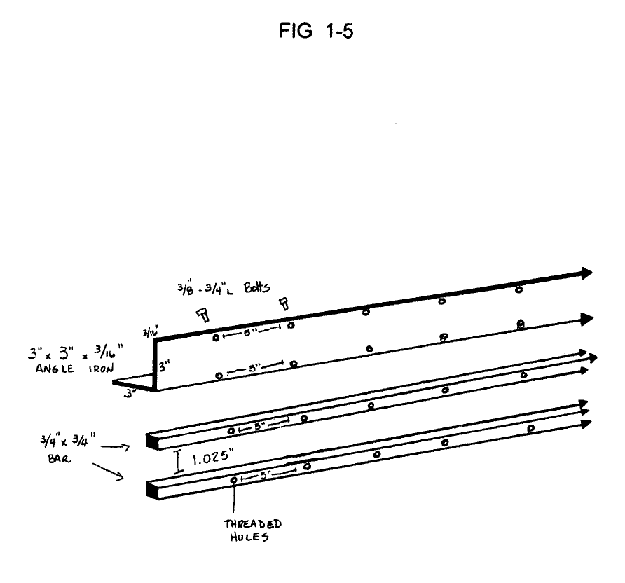

Photo 1-15 Shows the use of the power bed slide on a severe angle operating 2000 lb.

Photo 2-15 A view of the Power Bed Slide installed in a pick up truck.

Photo 3-15 Shows the center mounted hydraulic cylinder with deck fully extended.

Photo 4-15 Inside view of the track system.

Photo 5-15 Outside view of the track system.

Photo 6-15 Stationary track system showing slide out extended and its bearings.

Photo 7-15 Push button switch for in and out operation.

Photo 8-15 Stationary track system showing slide out in closed position.

Photo 9-15 Shows Power Bed Slide in closed position mounted in the back of a pick-up truck.

Photo 10-15 Shows Power Bed Slide framework. Shows hydraulic cylinder fully extended. Shows one bolt to remove deck from track system.

Photo 11-15 Shows 12 v powered hydraulic pump with reservoir and control switch. Operating pressure 2500 psi. Flow rate 1.7 gallons/minute.

Photo 12-15 Power Bed Slide fully extended by hydraulic cylinder (without deck).

Photo 13-15 Cutaway view of tracks with Power Bed Slide extended.

Photo 14-15 Head of hydraulic cylinder.

Photo 15-15 Removable deck with removal of just one bolt.

### DETAILED DESCRIPTION OF THE INVENTION

### Track System

The purpose of the track system is to provide stationary tracks for the hydraulic operated slide out deck to move. The length of the tracks determines the length of the finished unit. The length of the finished unit depends on space available in the vehicles cargo area. In this description, we will use a standard size pick-up truck bed, with the space available being 4′×6′.

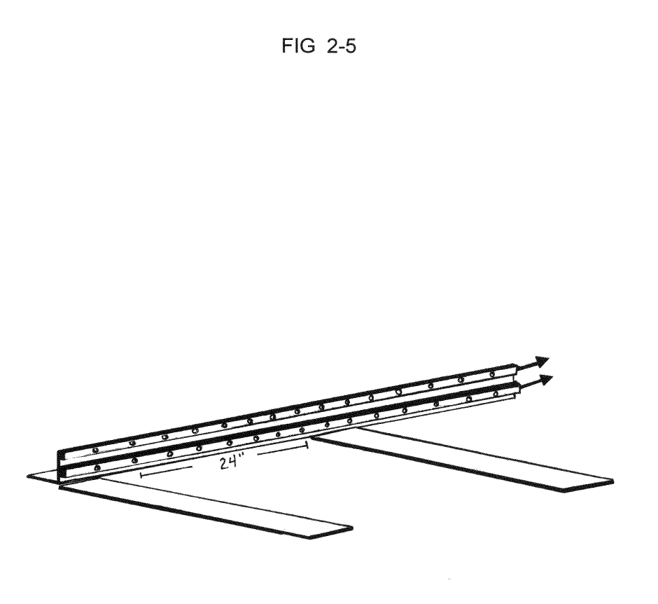

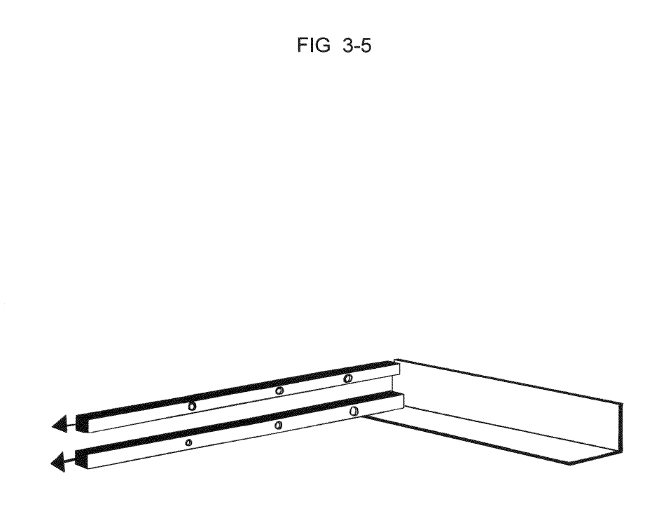

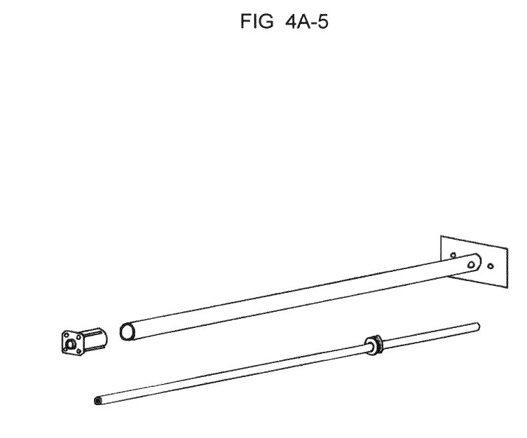

The key ingredient for the unit to hold a lot of weight is the track system and how it is built. The track consists of 3/16″×3″×3″ angle iron, ¾″×¾″ square bar and ⅜″×3″ flat stock.
1. Cut metal as follows:
   3/16″×3″×3″ Angle—2 pieces 72″ long each, 1 pieces 42″ long each.
   ¾″×¾″ Square bar—4 pieces 72″ long each.
   ⅜″×3″ Flat stock—2 pieces 42″ long each.
2. The Angle is drilled with two rows of ⅜″ holes every 5″ on both 72″ long pieces. (The two rows of holes are spaced so that when the square bar is attached, there is a space of 1.025″ between the rows.) The square bar is drilled with ⅜″ threaded holes every 5″.
3. To assemble, the square bar is bolted to the angle with ⅜″, 8-grade bolts and is assembled in a jig to achieve a gap of 1.025 inches for the bearings to ride in. Before removing the track system from the jig, each bolt is torqued to 50 lbs and then welded in place.
4. To connect the left and right tracks, weld the ⅜″×3″×flat stock (rungs) to both the left and right tracks. See FIG. 2-5. One rung is attached at the end of the tracks, the second is spaced 24 inches in from the first rung.
5. At the other end of the tracks, weld the 3/16″×3″×42″ long which is where the hydraulic cylinder mounts. See FIG. 3-5. The bolt spacing would be 6″ centered on the angle.

### Hydraulic Cylinder

The hydraulic cylinder operates the bed slide in and out of the tracks and connects to the end of the platform using one bolt thus making the platform completely removable by unfastening one bolt.

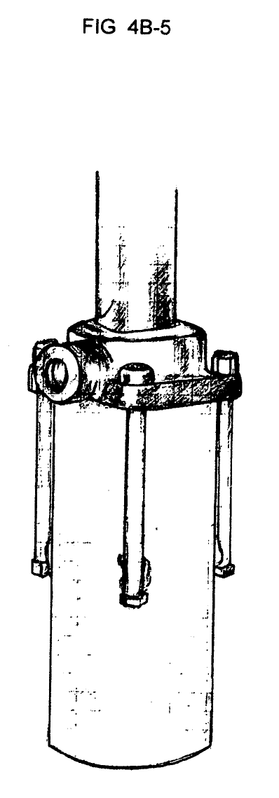

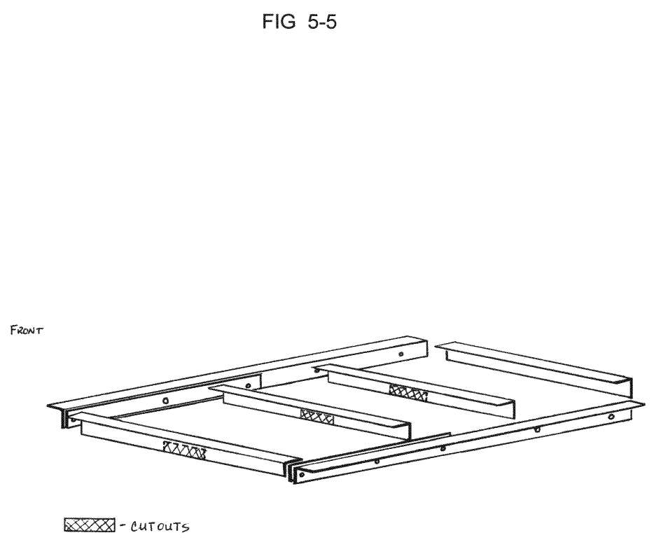

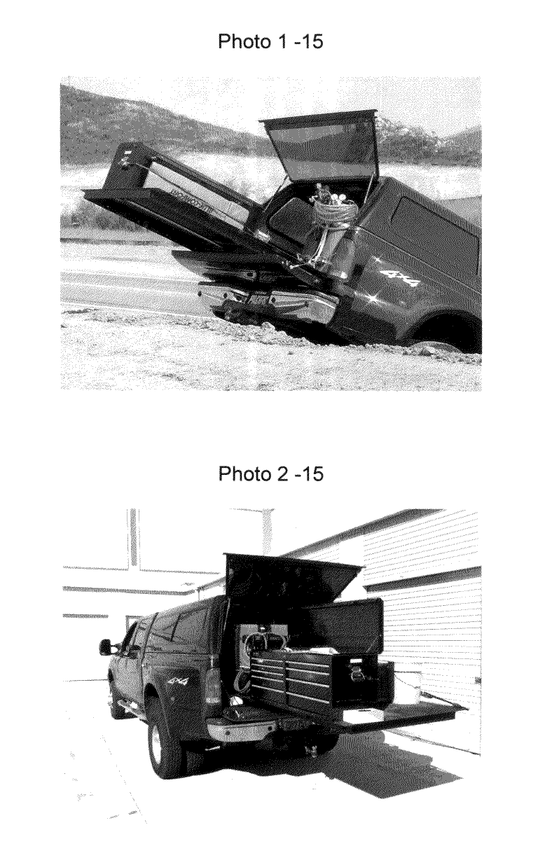

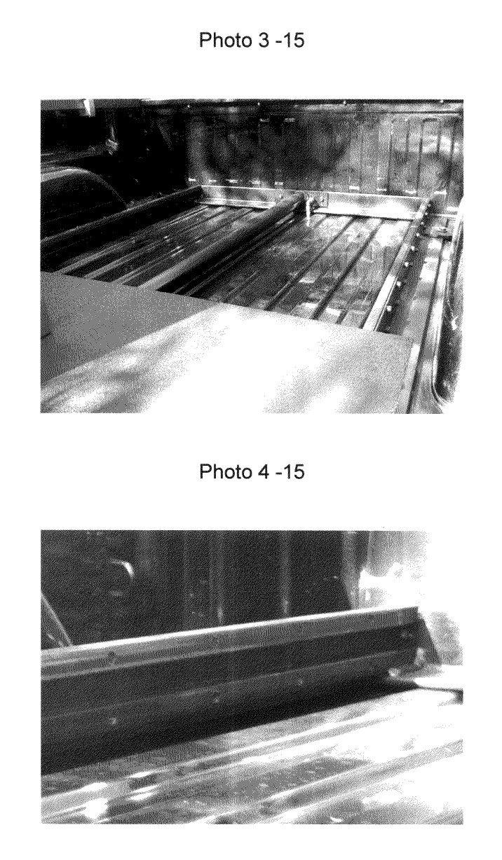

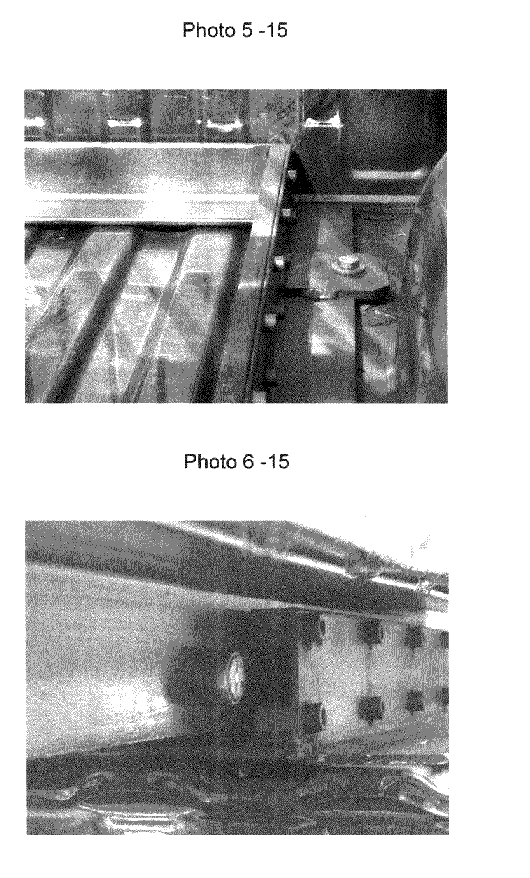

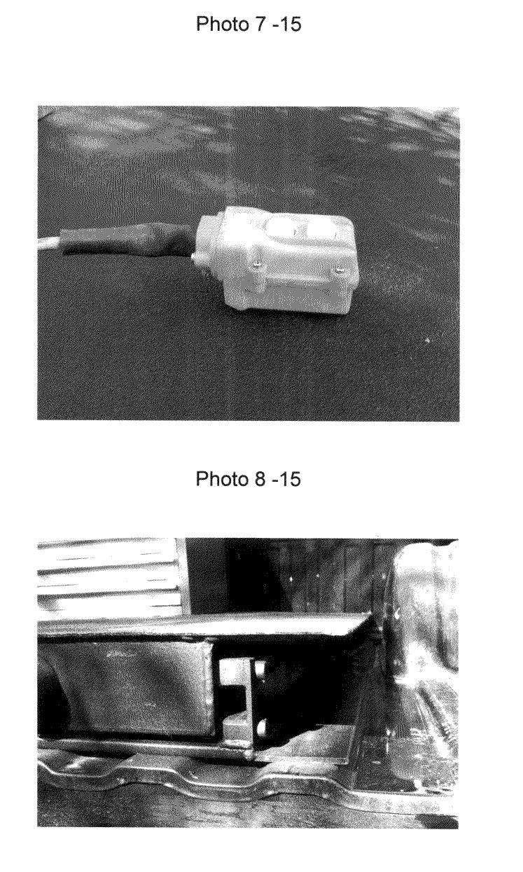

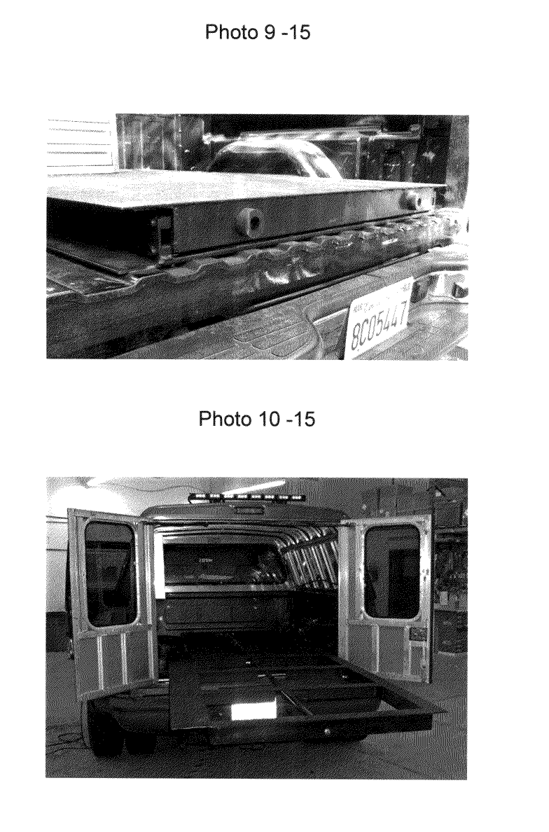

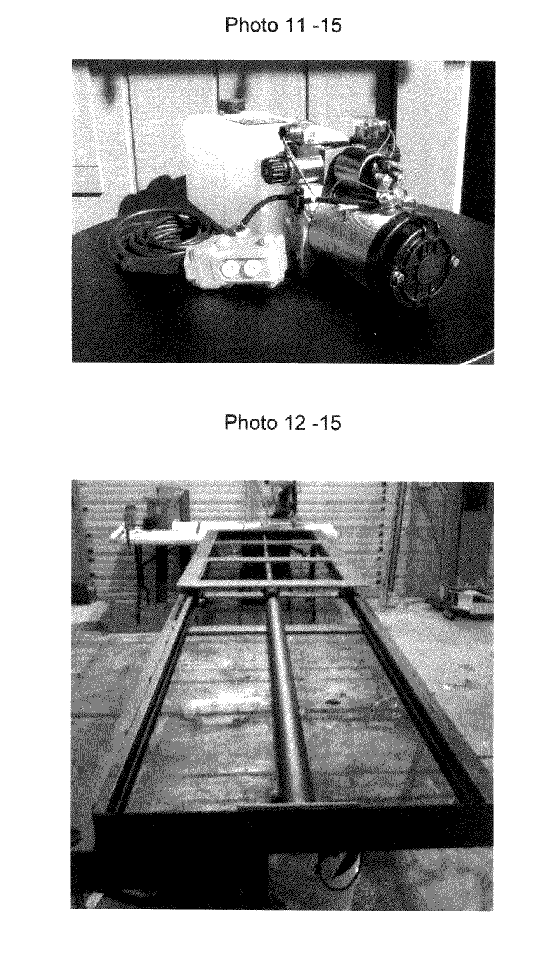

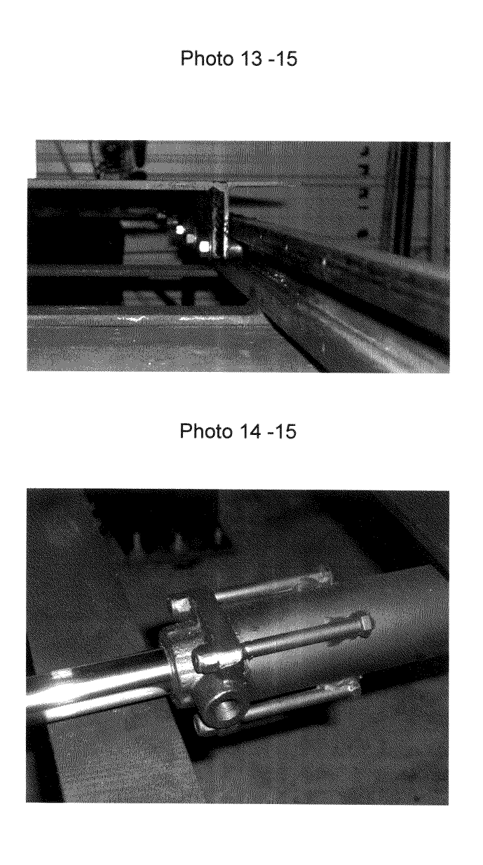

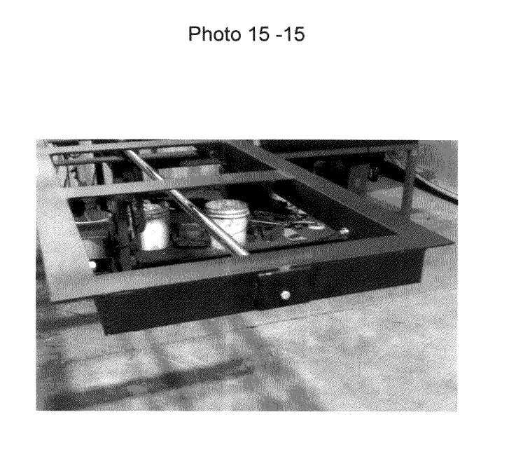

Mounted to the center of the track system on one end is a 2-way acting hydraulic cylinder with a port on each end of the tube. The tube is 2½″ O.D. and 2″ I.D. and is honed. The cylinder rod is chromed and hardened, and is 1¼″ in diameter. The rod end is tapped and floating. The hydraulic cylinder head is a manufactured part and holds the seals. The piston is a manufactured part that holds the seals inside the tubing. The piston also serves as the stopping mechanism for the travel of the bed slide depending on where it is welded to the rod.
1. Cut rod and tube as follows (for 4′×6′ example):
   2½″ Metal Tube—66″ long.
   Chrome rod—72″ long.
   3″×⅜″ Flat bar—1 piece 8″ long (for mounting).
2. Drill two ⅜″ holes in 3″×8″×⅜″ flat bar 1″ in from each end and centered. Weld to tube end. Weld on bottom port 6″ from mounting plate to side of tube. Weld four ⅜″ cylinder head mounting studs on other end of tube.
3. Thread ⅜″ hole into rod end. Weld piston to rod 54″ from threaded end of rod. Install hydraulic seals onto piston. Insert rod assembly into tube. See FIG. 4A-5
4. Install hydraulic seals into cylinder head and bolt head to cylinder using the welded mounting studs. See FIG. 4B-5.

### Slide Out Deck (Bed Slide)

The purpose of the slide out deck is to extend-the cargo out beyond the back of the truck automatically on any angle while supporting the maximum amount of weight allowed by the design of the vehicle. It consists of a 3″×3″× 3/16″ angle iron framework with 2 struts ⅜″ ×3″×32″ flat bar. It has ten 1″ cam-follower bearings (5 on each side). See FIG. 6. The deck plate cover is ⅛″ sheet metal, 4′×6′.
1. Cut metal as follows (for 4′×6′ example):
   3/16″×3″×3″ Angle—2 pieces 72″ long each, 2 pieces 39¾″ long each and 2 pieces 38½″ long each.
   3″×⅜″ flat bar —2 pieces 32″ long each (struts).
2. Drill five 7/16″ holes in the two 72″ long pieces of angle (these will be the left and right side of the platform for the deck). The vertical location of the holes is 1″ away from the long edge of the metal. The first hole is drilled 1″ from the end, the second is drilled 17″ from the end, the third is drilled 27″ from the end, the fourth is drilled 47″ from the end and the fifth is 67″ from the end.
3. Drill three 7/16″ holes in the two 32″ long struts. The vertical location of the holes is 1″ away from the long edge of the metal. The first hole is drilled 1″ from the end, the second is drilled 17 from the end, and the third is drilled 27″ from the end. See FIG. 5.
4. Clearance space for the cylinder must be cut out of the two 38½″ long pieces of angle and one of the 39¾″ pieces of angle. The clearance spaces are 5″×2″ and are centered. See FIG. 5-5. In the 39¾ piece of angle with NO clearance space, drill a ⅜″ hole centered on one side of the angle 1″ from long edge.
5. To assemble, weld each of the 72″ long pieces of angle to the corresponding struts so that the holes line up in both pieces.
6. Weld the 39¾″ piece of angle with NO clearance space cut out to the ends of the two 72″ long pieces of angle (making sure it is the end that has NO struts welded on). See FIG. 5-5
7. Two feet in from the end welding in #6, weld in the 39¾ piece of angle (with clearance space cut out). Weld one of the 38½″ pieces four feet from end and the weld the second 38½″ piece to the other end.
8. Install bearings in drilled holes using 7/16″ nuts.
8. Weld ⅛″ sheet metal deck to top of platform. Spot weld every 5 inches on all four sides. Spot weld deck to rungs every 5 inches.

### Assembly and Installation:

1. Mount cylinder tang end to track using two ⅜″ nuts and bolts.
2. Slide platform into tracks.
3. Attach cylinder end to platform using a ⅜″ bolt.
4. Bolt the tracks to cargo area of vehicle using six ½″ 8-grade bolts and backup plates.
5. Mount hydraulic pump to frame of vehicle. Attach hydraulic lines—port A to head of cylinder, port B to tank end of cylinder.
6. Attach 2 guage battery cables to battery and to terminal on hydraulic pump.
7. Attach hand control to pump. Fill reservoir with hydraulic oil.
8. Test operation.

### Hydraulic Pump

The hydraulic pump is mounted to the frame. Operation A connects to the head of the hydraulic cylinder. Operation B connects to the base of the hydraulic cylinder. Eight gauge 12 volt power source to motor is needed.

### Mounting the Base/Track System

Simply drill four ½″ holes through the base, through the pick-up bed, and install back-up plates.

1. The Power Bed Slide enables you to automatically extend cargo/equipment out of the back of the truck on severe inclines as well as normal conditions. (See Photo 1-15)

2. The center-mounted hydraulic cylinder extends out moving with it a platform equal in size to the cargo area in the vehicle installed. Hydraulic power also pulls the platform back into the vehicle in which it is installed.

3. The platform is designed to accommodate the maximum carrying capacity of the vehicle in both the retracted and extended positions.

4. The platform can be easily removed from the vehicle without removing the hydraulic system or the tracks.

5. The Power Bed Slide uses a hydraulic pump that is frame-mounted onto the vehicle.

6. The stopping mechanism for the Power Bed Slide in both the open and closed positions is achieved by piston placement inside the hydraulic cylinder.
